(19) United States
(12) Patent Application Publication
(10) Pub. No.: US 2008/0222792 A1
(43) Pub. Date: Sep. 18, 2008

(54) Abrasive foot mat

(76) Inventor: Portia Koutsoumbos, Vernon, CT (US)

Correspondence Address: JAMES RAY & ASSOCIATES, 2640 PITCAIRN ROAD, MONROEVILLE, PA, 15146, US

(21) Appl. No.: 12/082,430

(22) Filed: Apr. 11, 2008

Related U.S. Application Data
(63) Continuation-in-part of application No. 11/258,501, filed on Oct. 25, 2005, now abandoned.

(51) Int. Cl. A47K 3/00; B29C 65/44

(52) U.S. Cl. 4/583; 156/245

(57) ABSTRACT

An apparatus for providing foot care. Such apparatus comprises a base member having a predetermined shape and having an upper surface and a bottom surface. There is an abrasive means permanently bonded to an upper surface of the base member and there are a plurality of suction cups disposed on the bottom surface of the apparatus for releasably securing the apparatus to a solid surface such as base of a bathtub or shower stall.

### CROSS REFERENCE TO RELATED APPLICATION

This application is a Continuation-in-Part Application and claims priority benefits of co-pending patent application Ser. No. 11/258,501 filed Oct. 10, 2005. The teachings of this related application are incorporated herein by reference thereto.

### FIELD OF THE INVENTION

The present invention relates, in general, to a mat for use in a bathtub or shower, and, more specifically the present invention relates to a bath mat having an abrasive surface layer for foot care.

### BACKGROUND OF THE INVENTION

Human foot problems have merited an ever increasing attention from the population in general, and even more concern with persons who are diabetic. It has been known that skin built upon the foot such as calluses or corns has been a recurring problem to such feet that been subjected to prolonged friction and pressure. With the increased time that people have been spending in shoes while walking on concrete or other hard surfaces these problems has increased dramatically.

Medicated pads have been used to alleviate some of the problems with corns and foot creams and abrasive materials such as files or sloughing creams aid in the removal of hardened skin or calluses. However, these have not always been found to be an adequate solution. Part of the reason for failure of many of these aids has been the time required to work on the such foot problems. Thus, it would be advantageous if such foot problems, such as dry skin or calluses, could be addressed while doing other activities such as bathing or showering.

### SUMMARY OF THE INVENTION

In a first aspect the present invention provides an apparatus for providing each of a non-slip surface on the bottom of the apparatus for engagement with at least one of a bath tub and a shower stall and for providing foot care of an individual's feet. The apparatus comprises an abrasive material selected from a group including pumice, aluminum oxide and combinations thereof. A base member formed from a substantially solid flexible material selected from a group including natural rubber, synthetic rubber and combinations thereof having each of a predetermined shape, a first substantially uniform predetermined thickness and a substantially flat bottom surface. A substantially flat upper surface of the base member formed around such abrasive material such that an upper surface of the base member is depressed by and bonded to a bottom surface of the abrasive material so that an upper surface of the abrasive material extends above the base member for a predetermined thickness. There is also a means disposed on at least a portion of the substantially flat bottom surface of the apparatus for releasably securing the apparatus to a solid surface.

In a second aspect the present invention provides a method of making an apparatus for providing foot care. The method comprises the steps of providing an abrasive material formed into a sheet. Placing a predetermined amount of a preselected rubber composition into a mold and placing a section of the abrasive material on top of the rubber composition in the mold. Placing such mold filled with the preselected rubber composition and the abrasive material into a heating compartment. Heating such mold to a predetermined temperature and for a predetermined time. Melting the preselected rubber composition so as to have the rubber composition being formed around the abrasive material such that an upper surface of the preselected rubber composition is depressed by and bonded to a bottom surface of the abrasive material so that an upper surface of the abrasive material extends above the preselected rubber composition base member for a predetermined thickness.

### OBJECTS OF THE INVENTION

It is, therefore, one of the primary objects of the present invention to provide a bath mat which has an abrasive upper surface.

Another object of the present invention is to provide a bath mat which can provide foot care without the need of bending over.

Still another object of the present invention is to provide a bath mat which will stick to bath tub or shower base.

Yet another object of the present invention is to provide a bath mat wherein such abrasive upper surface will remove dry skin from the soles of the feet by rubbing over the abrasive surface.

Another object of the present invention is for the abrasive material to be aluminum oxide.

Still another object of the present invention is to have the abrasive material bonded directly into the surface of the base material.

Another object of the present invention is have the base material selected from a rubber composition.

Yet another object of the present invention is to melt such rubber composition with such abrasive material disposed on the surface wherein the abrasive material is bonded to the rubber composition.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a top view of the present invention showing the abrasive surface.

FIG. 2 is a bottom view of such mat shown in FIG. 1 showing a means for securing such mat according to an embodiment of the invention.

FIG. 3 is cross sectional view of the mat shown in FIGS. 1 and 2.

FIG. 4 is an end view of the present invention according to an alternate embodiment.

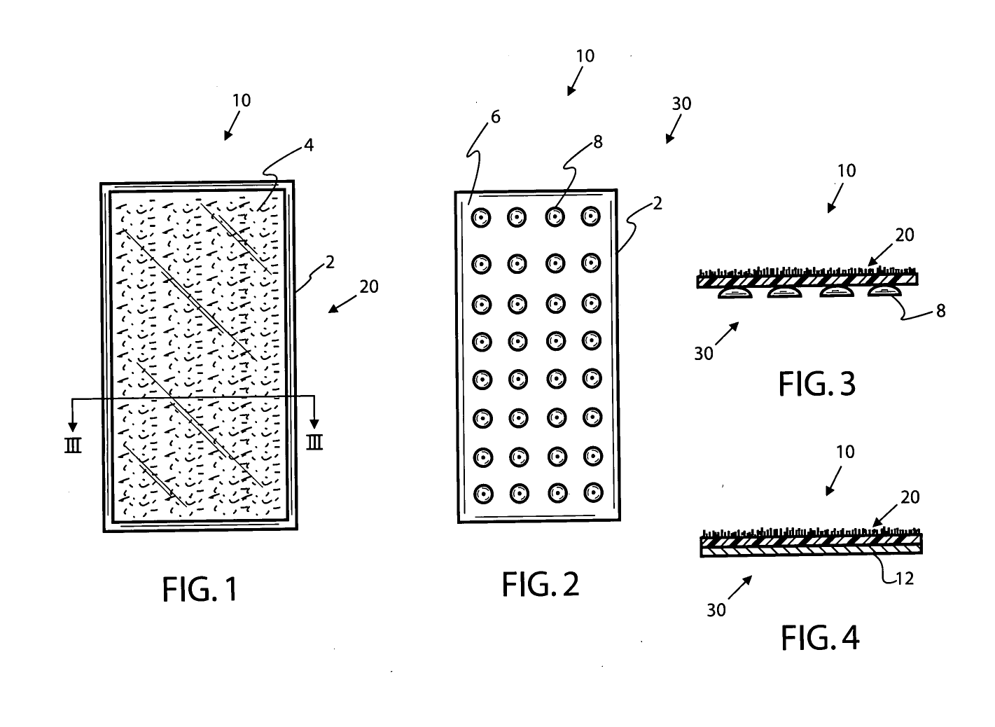

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing each of a non-slip surface on the bottom of the apparatus for engagement with at least one of a bath tub and a shower stall and for providing foot care of an individual's feet. The apparatus 10 comprises an abrasive material, generally designated 20, selected from a group including pumice, aluminum oxide and combinations thereof. A base member 2 formed from a substantially solid flexible material selected from a group including natural rubber, synthetic rubber and combinations thereof having each of a predetermined shape, a first substantially uniform predetermined thickness and a substantially flat bottom surface 6. A substantially flat upper surface 4 of the base member formed around such abrasive material 20 such that an upper surface 4 of the base member is depressed by and bonded to a bottom surface of the abrasive material 20 so that an upper surface of the abrasive material 20 extends above the base member 2 for a predetermined thickness. There is also a means 30 disposed on at least a portion of the substantially flat bottom surface 6 of the apparatus 10 for releasably securing the apparatus 10 to a solid surface.

Such bonding between the abrasive material 20 and the rubber formulation, of the base member 2, that flows around the abrasive material 20 is a permanent bond.

The abrasive material 20 could be adhered to the base material 2 with adhesives as is done in prior art; however such adhesion is not permanent as with time and usage the adhesive material breaks down and the abrasive material is not retained.

Although there are a variety of abrasive means 20 that can be used, such as alumina and pumice mentioned previously, according to a presently preferred embodiment of the invention such abrasive means is aluminum oxide.

Further, the means 30 disposed on the bottom surface of the apparatus 10 for releasably securing the apparatus 10 to a solid surface includes one of at least one suction cup, at least one magnet and double sided tape. It is presently preferred that such means disposed on the bottom surface 6 for releasably securing the apparatus 10 to a solid surface includes a plurality of suction cups 8.

In the embodiment that includes double sided tape 12, as seen in FIG. 4, for securing such apparatus 10 it is preferred that such double sided tape 12 have different adhesive characteristics on each side of the double sided tape 12. The adhesion between the tape 12 and the bottom surface 6 of the apparatus 10 should be a relatively strong bond whereas the characteristics of the adhesive bonding the tape 12 to the solid surface should be a relatively light bond so the apparatus 10 can be removed easily. Such embodiment utilizing magnets would only be useful for engaging the tub bottom and not useful for shower stalls having a rubberized or plastic bottom.

Such apparatus 10 provides foot care by passing a foot across the abrasive surface 20 thereby removing dead skin and repeatedly passing the foot over the abrasive surface 20 with some pressure can reduce the problem with calluses on the bottom of the foot.

In a presently preferred embodiment of the invention such base member 2 is formed of a combination of natural rubber and synthetic rubber. Although the apparatus 10 could be formed into a variety of shapes such as oval, circular, hexagonal, octagonal it is presently preferred that such predetermined shape of the base member 2 be substantially rectangular.

In a second aspect the present invention provides a method of making an apparatus 10 for providing foot care. The method comprises the steps of providing an abrasive material 20 formed into a sheet. Placing a predetermined amount of a preselected rubber composition into a mold and placing a section of the abrasive material on top of the rubber composition in the mold. Placing such mold filled with the preselected rubber composition and the abrasive material into a heating compartment. Heating such mold to a predetermined temperature and for a predetermined time. Melting the preselected rubber composition so as to have the rubber composition being formed around the abrasive material 20 such that an upper surface 4 of the preselected rubber composition is depressed by and bonded to a bottom surface of the abrasive material 20 so that an upper surface of the abrasive material 20 extends above the preselected rubber composition base member 2 for a predetermined thickness.

The predetermined temperature to which the apparatus is heated is between about 145 and about 155 degrees centigrade.

It is presently preferred that such preselected rubber composition is a combination of natural rubber and synthetic rubber.

The method further includes the step of providing a non slip surface on a bottom surface of the apparatus for releasably securing the apparatus to a solid surface. It is also presently preferred that such non slip surface is provided by a plurality of suction cups.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for providing each of a non-slip surface on the bottom of said apparatus for engagement with at least one of a bath tub and a shower stall and for providing foot care of an individual's feet, said apparatus comprising:
(a) an abrasive material selected from a group including pumice, aluminum oxide and combinations thereof;
(b) a base member formed from a substantially solid flexible material selected from a group including natural rubber, synthetic rubber and combinations thereof having each of a predetermined shape, a first substantially uniform predetermined thickness and a substantially flat bottom surface, a substantially flat upper surface of said base member formed around said abrasive material such that an upper surface of said base member is depressed by and bonded to a bottom surface of said abrasive material so that an upper surface of said abrasive material extends above said base member for a predetermined thickness; and
(c) a means disposed on at least a portion of said substantially flat bottom surface of said apparatus for releasably securing said apparatus to a solid surface.

2. The apparatus, according to claim 1, wherein said abrasive means is aluminum oxide.

3. The apparatus, according to claim 1, wherein said means disposed on said bottom surface of said apparatus for releasably securing said apparatus to a solid surface includes one of at least one suction cup, at least one magnet and double sided tape.

4. The apparatus, according to claim 3, wherein said means disposed on said bottom surface of said apparatus for releasably securing said apparatus to a solid surface includes a plurality of suction cups.

5. The apparatus, according to claim 3, wherein said means disposed on said bottom surface of said apparatus for releasably securing said apparatus to a solid surface includes said double sided tape.

6. The apparatus, according to claim 5, wherein said double sided tape has different adhesive characteristics on each side of said double sided tape.

7. The apparatus, according to claim 3, wherein said means disposed on said bottom surface of said apparatus for releasably securing said apparatus to a solid surface includes a plurality of magnets.

8. The apparatus, according to claim 1, wherein said base member is formed of a combination of natural rubber and synthetic rubber.

9. The apparatus, according to claim 1, wherein said predetermined shape of said base member is generally rectangular.

10. A method of making an apparatus for providing foot care, said method comprising the steps of:
(a) providing an abrasive material formed into a sheet;
(b) placing a predetermined amount of a preselected rubber composition into a mold;
(c) placing a section of said abrasive material on top of said rubber composition in said mold;
(d) placing such mold filled with said rubber composition and said abrasive material into a heating compartment;
(e) heating such mold to a predetermined temperature and for a predetermined time; and
(f) melting said rubber composition so as to have said rubber composition being formed around said abrasive material such that an upper surface of said base member is depressed by and bonded to a bottom surface of said abrasive material so that an upper surface of said abrasive material extends above said base member for a predetermined thickness.

11. The method, according to claim 10, wherein said predetermined temperature is between about 145 and about 155 degrees centigrade.

12. The method, according to claim 10, wherein said preselected rubber composition is a combination of natural rubber and synthetic rubber.

13. The method, according to claim 10, wherein said method includes a step of providing a non slip surface on a bottom surface of said apparatus for releasably securing said apparatus to a solid surface.

14. The method, according to claim 13, wherein said method includes the step of providing said bottom surface of said apparatus with a plurality of suction cups.
